(19) United States
(12) Patent Application Publication
(10) Pub. No.: US 2009/0016725 A1
(43) Pub. Date: Jan. 15, 2009

(54) WAVELENGTHS MULTIPLEXER METHOD AND APPARATUS FOR OPTICAL LOGGING TOOLS

(75) Inventors: Christian Chouzenoux, St. Cloud (FR); Antoine Saliou, Paris (FR)

Correspondence Address: SCHLUMBERGER K.K., 2-2-1 FUCHINOBE, SAGAMIHARA-SHI, KANAGAWA-KEN, 229-0006, JP

(73) Assignee: SCHLUMBERGER TECHNOLOGY CORPORATION, Sugar Land, TX (US)

(21) Appl. No.: 11/770,750

(22) Filed: Jun. 29, 2007

(51) Int. Cl. H04J 14/02

(52) U.S. Cl. 398/79; 340/853.1

(57) ABSTRACT

A wavelengths based multiplexer for an optical logging tool method and apparatus comprising a plurality of thin film filter sets and architecture to perform optical wavelength multiplexing without bending an optical fiber within the multiplexer. This enables the multiplexer to be used in a down hole, well logging, tool environment.

### TECHNICAL FIELD

This invention relates to a method and apparatus for compact multiplexing of optical carried data for logging tools used in oil and gas industry. More specifically, this invention relates to a wavelengths division multiplexer method and apparatus having a compact architecture for logging tools which obviates optical fiber bending within the logging tool.

### BACKGROUND OF THE INVENTION

Optical networks are commonly used in telecommunications for data transmission. A high transmission data rate is obtained by increasing the number of wavelengths propagating on the same fiber. Each wavelength is associated to a communication channel. Optical filter systems have been developed to selectively route different wavelengths along the network. These optical components allow adding or dropping wavelengths at each node along the fiber. Several filters can be combined in the same device to form an optical multiplexer (or demultiplexer).

Multiplexers based on wavelength division classically include a set of devices, which successively separate and isolate the different wavelengths. Several different technologies can be used such as arrayed waveguide grating and thin film filters. In the past thin film filters have been combined in series to form wavelengths based multiplexers. The principle of thin film multiplexing is based on backward reflection and an interaction of a light-wave on a plurality of thin film filters.

Each thin film filter outputs a signal that is centered on an associated wavelength whereas a reflected signal is input in the next filter. The filters are connected in series, one wavelength being extracted at each level and extended to “N” wavelengths. The number of filters required for a multiplexer is equal to “N,” the number of wavelengths to be separated.

A major constraint for previously known optical multiplexers is in the serial connection of sequential filters. At each level, a reflected port is connected to a successive filter input port. Consequently, the optical fiber must be bent by 180 degrees for connection to a successive filter input port. The radius of curvature of this half turn must be greater than the bend radius of the fiber. The maximum bend radius of a typical optical fiber (SMF 9/125, MMF 50/125) is approximately 25 mm. This bending radius leads to a significant size dimension, at least in one direction. In previously known multiplexers sizes larger than 100 mm in one dimension were not unusual.

Although this size may not be a limiting issue for many telecommunications applications, multiplexer size is a constraint for some applications such as borehole logging in the oil and gas industry. The physical restrictions in a borehole require a small tool diameter. A standard tool diameter size is approximately one and eleven sixteenths inches but even smaller diameters (below one inch) are desirable for some applications to pass borehole restrictions related to equipment for oil and gas production control (safety valves, production packers, down hole flow control and monitoring equipment).

A wide range of optical sensors have been developed, such as thermal, mechanical and electromagnetic. By operating at different wavelengths, data from the optical sensors can be multiplexed on the same fiber. This feature allows connecting only one fiber while performing measurements from several sensor sources.

Although classical multiplexer architecture has many benefits and has been useful in telecommunications applications, in the context of optical logging tools for oil and gas wells, conventional multiplexing architecture and size of previously known optical multiplexer systems is not well adapted for down hole sensing constraints and borehole geophysics applications. First, logging for oil and gas wells requires an extremely small dimension of the multiplexer due to the limited borehole diameter, especially in the case of production wells. Second, a small radial dimension of down hole logging tools does not permit bending of the optical fiber by an acceptable bend radius of the optical fiber.

The problems with multiplexing down hole data onto a single optical fiber discussed in the preceding are not intended to be exhaustive but rather are among many which demonstrate that optical, logging tool, multiplexing know in the past will admit to worthwhile improvement. In this, it would be desirable to provide compact optical multiplexing apparatus for multiplexing data from different sensors on the same fiber within the above logging tool constraints.

### BRIEF SUMMARY OF THE INVENTION

One embodiment of the invention comprises a method and apparatus for separating down hole discrete wavelengths carried down hole on an optical fiber for use in an optical well logging tool. In one specific example, a logging tool is equipped with three optical sensors performing borehole parameter measurements, such as temperature, pressure or borehole fluids characteristics. Each sensor measurement is attached to a given optical carrier wavelength. The multiplexer consists of a combination of three thin film filters, each with one input and two output ports. Each filter transmits a signal centered on a given wavelength, and reflects all complementary wavelengths. With the subject invention optical multiplexer architecture an input signal is fully multiplexed and each spectral component is isolated for use as a data carrier and return through the multiplexer back onto the optical fiber for transmission to the surface for data analysis.

### THE DRAWINGS

Other aspects of the present invention will become apparent from the following detailed description of embodiments thereof taken in conjunction with the accompanying drawings wherein:

FIG. 1 is a graphic view of a wire line logging tool positioned within a hydrocarbon well, which schematically demonstrates an operating context of the invention;

FIG. 2A is a schematic representation of a classical technique of a wavelength division multiplexer/demultiplexer;

FIG. 2B is a graphic representation of the operation of an optical thin film multiplexer employing the use of a mirror;

FIG. 3 is a schematic representation of one preferred embodiment of an optical multiplexer for three (3) discrete optical wavelengths;

FIG. 4 is a schematic representation of an embodiment of an optical multiplexer for “N” optical wavelengths; and

FIG. 5 is a graphic view of a three wavelength, optical multiplexer positioned within the context of a logging tool in accordance with one preferred embodiment of the invention.

### DETAILED DESCRIPTION

### Context of the Invention

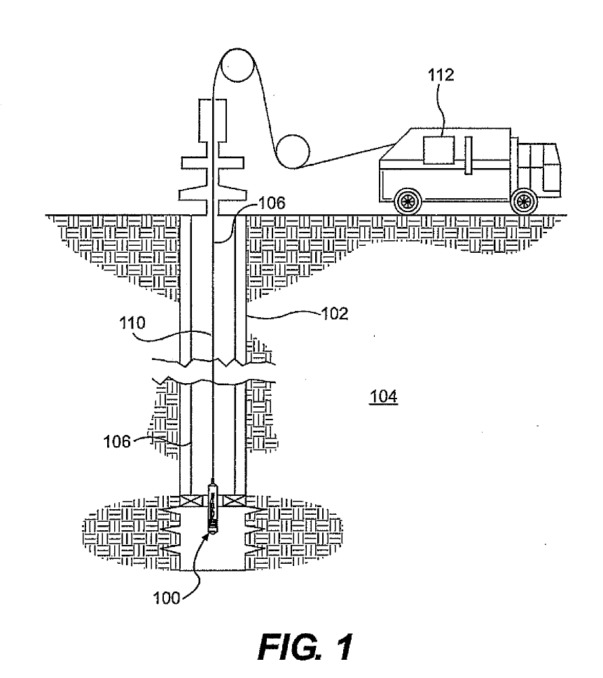

Referring now to the drawings and particularly to FIG. 1, an illustration of an operational context of the instant invention is shown. In this, wireline logging tool 100 is shown positioned within a well casing 102 and production tubing 106 cemented into an earth formation 104. The logging tool is designed for analyzing gases, fluids, and other materials from the formation 104. The wireline logging tool 100 is lowered into and suspended adjacent a production formation 104 from the distal end of a wireline or slick line 110. The slick line 110 is lowered from the surface of the borehole and carries, inter alia, an optical fiber for high speed data communication between the logging tool 100 and the surface.

On the surface the optical fiber is coupled to an opto-electronic recorder 112 for borehole data storage and processing. The logging tool 100 is equipped with a plurality of sensors and an optical multiplexer in accordance with the invention for assisting in transmission of the down hole data to the electronic recorder 112. Three typical borehole parameters that are measured comprise temperature, pressure, or borehole fluids characteristics.

Each sensor measurement is carried on a designated optical wavelength. These wavelengths are emitted simultaneously by the opto-electronic surface system 112 and propagate via a single optical fiber down to an optical multiplexer. The multiplexer ensures that an appropriate wavelength is dropped onto each sensor. Down hole data is then coupled with a specific optical carrier wavelength and reflected back through the multiplexer up to the surface for processing and storage as will be described below.

FIG. 1 depicts a wireline logging tool 100. However, it is contemplated that the principles described herein have applicability to other contexts relating to the specific embodiments herein, such as production logging, permanent monitoring, drilling and measuring, among others. Similarly, other methods of deployment, sensors, and other devices, in addition to the examples cited herein, may be utilized in practice of the principles described herein.

### Wavelength Based Optical Multiplexers

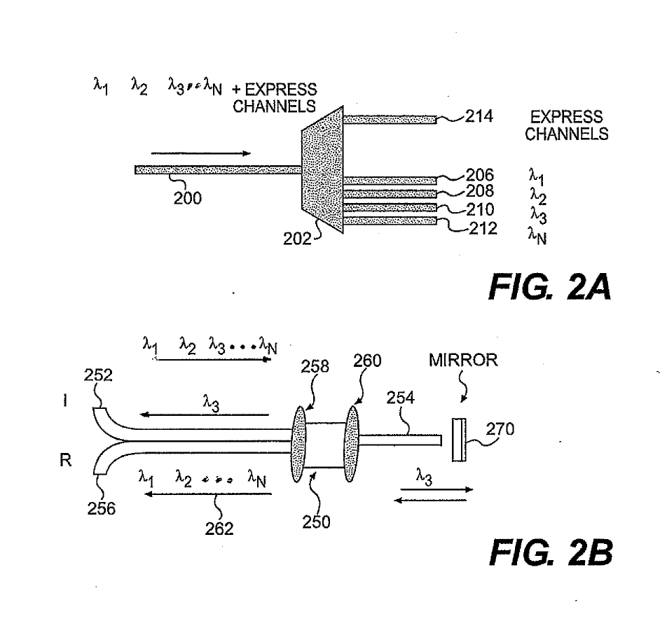

FIG. 2A schematically represents a classic structure for a wavelength division, optical multiplexer/demultiplexcr. In this, an incident light-wave 200 carries “N” discrete wavelengths “k” plus other components referred to as express channels. An optical multiplexer 202 comprises a system and apparatus for dropping select wavelengths λ1 to λN on separate output ports 206-212. The remaining unfiltered light wave or express channel is available at the last output fiber 214. The “N” output fibers selectively carry the filtered light wave components, which are isolated and extracted from the input light-wave components 200.

Optical multiplexers classically employ thin film filters to implement wavelength selection. One example of a thin film filter is disclosed in U.S. Pat. No. 4,373,782. The disclosure of this patent is incorporated by reference as though set forth at length.

FIG. 2B shows an optical filtering arrangement based on a thin film filter 250 designed to isolate a selected wavelength of light. The optical filter arrangement has an optical input port 252 plus two output ports 254 and 256, descriptively designated transmission “T” and reflection “R” ports respectively. A Graded Index (GRIN) lens is positioned at each end of the thin film filters to form an optical filter set suitable to collimate optical wavelengths and transmit or reflect discrete optical wavelengths as will be discussed below.

In operation a bundled optical waveform 262 comprising wavelengths λ1 . . . λN is input via the optical fiber port 252 towards a first Graded Index (GRIN) lens 258. The optical filter 250 is positioned in series behind the first GRIN lens 258 and in front of a second GRIN lens 260. The optical filter 250 comprises an assembly of conventional thin films. The thin films are designed to pass wavelength components λ3 within a range corresponding to a preset central wavelength. The other wavelength components λ1, λ2, . . . XN, are reflected backward along the reflection port 256. The part of the signal whose energy is centered on the filter central wavelength λ3 passes through the thin films and is collimated by the second GRIN lens 260 into the transmission fiber 254. The complementary part of the signal 262 comprising wavelengths λ1, λ2, . . . -80 N is reflected backward by the filter 250 and passes back though the input GRIN lens 258. This lens performs collimation into the reflection port fiber 256. If a mirror 270 is placed at the end of the transmission port 254, the signal λ3 carried by the transmission port 254 is reflected back through the GRIN lens and thin filter set and the signal λ3 is propagated back onto the input fiber 252.

In order to provide a plurality of isolated wavelengths λ1, λ2, . . . λN the reflection port 256 can be bent 180 degrees and the above discussed architecture is repeated with a λ2 GRIN lens and thin filter set to isolate the λ2 wavelength. This process is repeated by bending the reflection port 180 degrees each time and selecting an appropriate thin filter set to isolate for multiplexing as many isolated wavelengths as desired. In other words, the filters are connected in series, one wavelength being extracted at each level, however, the optical fiber must be bent by 180 degrees for connection to a successive filter input port.

For an optical fiber the curvature radius of each half turn must be greater than the bend radius of the fiber. The maximum bend radius of conventional optical fiber (SMF 9/125, MMF 50/125) is approximately 25 mm. This bending leads to a significant dimension of optical multiplexers, at least in one direction. An optical multiplexer with a side longer than 100 mm is not unusual. In a telecommunications environment this size dimension may not be an issue, however, in a borehole logging environment where a standard diameter logging tool is 1 and 11/16 inches with even a one inch tool being desirable an optical multiplexer with the above 100 mm architecture is not acceptable.

### Compact Optical Multiplexer

In view of the foregoing, a new architecture which minimizes the overall size of the optical multiplexer and avoids any bending of the optical fiber would be highly desirable for a well logging environment.

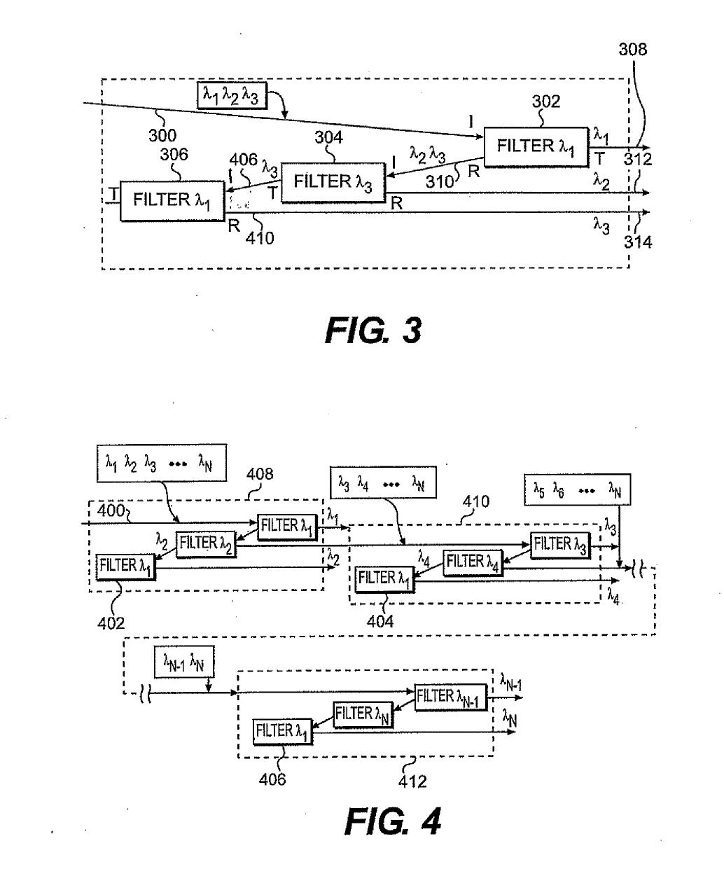

FIG. 3 is a schematic representation of one embodiment of the subject invention comprising an optical multiplexer for three (3) wavelengths λ1 , λ2 and λ3. Input wavelength 300 carrying wavelengths λ1, λ2 and λ3 is shown with no express channel and therefore no optical wavelengths other than λ1, λ2 and λ3.

The architecture comprises a combination of three (3) thin film filter sets 302, 304, and 306. Each filter set has one input port “I” plus two output ports namely a transmission port “T” and a reflection port “R” as discussed generally above. The first filter set 302 transmits a signal centered on λ1 to a transmission port 308 and diverts to the reflection port 310 complementary wavelengths λ2 and λ3.

The signal on the reflection port 310 comprising wavelengths λ1 and λ3 is then the input for the second filter set 304 that is centered on λ3. The wavelength λ2 is thus reflected by this filter set 304 and propagates towards a second channel 312. The second filter set 304 transmits wavelength λ3 to the third filter set 306. This filter set is selected to transmit only λ1, or alternatively only λ2, wavelengths and thus reflects λ3 optical wavelengths which propagate to a third channel 314. Alternatively, the third filter 306 could be replaced with an optical mirror with the same effect.

With this system architecture the input signal 300 has been fully multiplexed into three discrete channels without requiring a bend in the optical fiber. This architecture is of particular interest for a low number of wavelengths multiplexing as it permits a very compact assembly. Nevertheless, the principle can be extended to a large number of wavelengths. Complementary to these advantages, the three wavelengths multiplexer is implemented with only two types of thin film filters leading to worthwhile cost reduction.

The principle of the subject invention can be extended to N channels as shown in FIG. 4. The multiplexer is based on a serial combination of the previous three (3) wavelengths multiplexer. This architecture again ensures no bending of the optical fiber and all multiplexers can be aligned along the same direction. However, the number of filters increases with the number of outputs. Considering that the number of wavelengths “N” is odd, the number of filters necessary to multiplex “N” wavelengths is 3N/2 when an all filter set system is being used. This number of filters comes from the filter centered on wavelength λ1 as shown. The third filter 402, 404 and 406 could be replaced in each instance by a mirror. In a preferred architecture, however, input wavelength 400 carrying wavelengths λ1, λ2, λ3, . . . λN is processed by a series of serially connected three part multiplexer units. This system consists of a series of 3N/2 filters.

With this system, the input signal 400 can be fully multiplexed as each spectral component has been isolated. In this connection the first multiplexer subunit 408 divides out discrete wavelengths λ1 and λ2 with all of the remaining wavelengths being transmitted to the next multiplexer subunit in series 410. This sub-unit divides out two more wavelengths λ3 and λ4 and the remaining wavelengths are transmitted on for further multiplexing until the final wavelengths λXN−1 and 2N are isolated by the final sub-unit 412. The total number of three component sub-units that will be needed to isolate or multiplex “N” optical wavelengths will by N/2.

### Well Logging Multiplexer

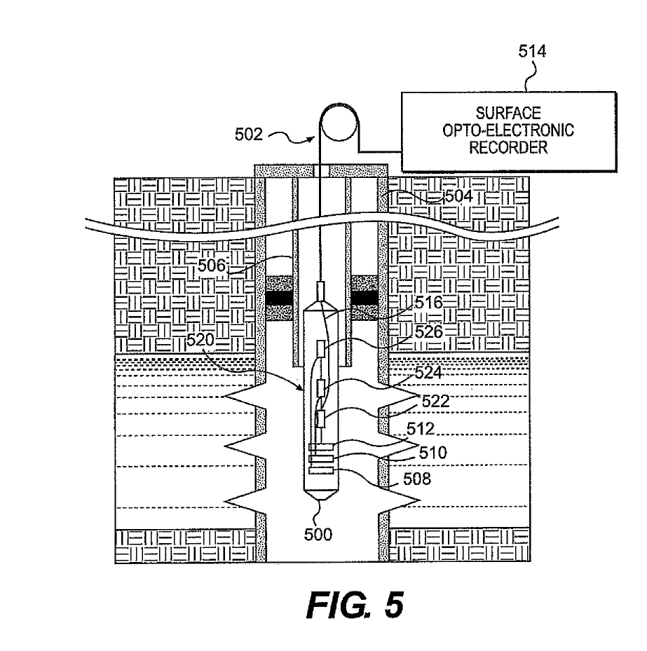

In the context of borehole geophysics, the multiplexer system described can be advantageously implemented in a down hole logging tool as shown in FIG. 5.

A borehole logging tool 500 is shown in this embodiment as being suspended from a conventional wireline 502 through a well casing 504 and production tubing to a geophysical production zone.

The logging tool 500 is equipped with three optical sensors 508, 510, and 512 for performing borehole parameter measurements, such as temperature, pressure, borehole fluid characteristics, or other measurements that are typically obtained in exploration and production of hydrocarbons. Each sensor measurement can be carried to the surface for processing and storage by a discrete wavelength of light λ1, λ2, or λ3. These wavelengths are initially emitted by an opto-electronic surface system 514 and propagate via a single fiber optic 516 carried along with the wireline 502 down to the logging tool 500

A three filter multiplexer 520 ensures that the appropriate optical wavelengths are dropped on each sensor. As discussed above, a first thin film filter 522 operably transmits wavelength λ1 onto sensor 512. The second thin film filter 524 transmits another wavelength λ3 and isolates and drops wavelength λ2 onto optical sensor 510. A third filter or mirror 526 then reflects the remaining third discrete wavelength λ3 onto optical sensor 508.

The separated wavelengths are then dropped onto individual data sensors 508, 510, 512, etc. where down hole data is attached and transmitted or reflected back through the multiplexer and onto the single fiber optic 516 for transmission of the data ladened wavelengths to the surface for demodulation and analysis. Each wavelength component λ1, λ2, and λ3 carrying optical sensor data is thus reflected or transmitted back through the multiplexer in the reverse direction and onto the single optical fiber up to the surface by for example a mirror placed at the termination of each optical sensor, according to the principle described in connection with FIG. 2B.

Although the multiplexer discussed in connection with FIG. 5 has a three component or wavelength architecture to isolate carrier wavelengths λ1, λ2, and λ3 the multiplexer architecture can be designed with additional wavelengths up to “N” in a manner as discussed in connection with FIG. 4.

The multiplexer 520 is placed inside a logging tool for protection against a surrounding aggressive borehole environment. Due to its architecture, a small diameter is achievable for the tool allowing access through the well tubing. This architecture is of particular interest for a low number of wavelengths multiplexing as it leads to a very compact assembly. Nevertheless, the principle can be extended, as discussed, to a large number of wavelengths, as desired, without bending optical fiber within or associated with the multiplexer.

The various aspects of the invention were chosen and described in order to best explain principles of the invention and its practical applications. The preceding description is intended to enable those of skill in the art to best utilize the invention in various embodiments and aspects and with modifications as are suited to the particular use contemplated. It is intended that the scope of the invention be defined by the following claims.

What is claimed:

1. An optical wavelengths multiplexer for a well logging tool comprising:
a first optical filter set, said first optical filter set having,
an input port operably connected to an optical fiber carrying at least three distinct optical wavelengths,
a transmission port downstream of said input port of first optical filter set and extending in the same general direction as said first optical fiber and said input port and being operable to transmit a first optical wavelength; and
a reflection port generally opposed to said transmission port for receiving reflected wavelengths not transmitted by said transmission port, said reflection port extending in a general direction approximately 180 degrees reversed from the direction of said transmission port and being operable to direct the second and third remaining optical wavelengths away from said first optical filter set;
a second optical filter set, said second optical filter set having,
an input port operably connected to said optical reflection port of said first optical filter set and being operable to receive transmission of said second and third wavelengths from said first optical filter set,
a transmission port downstream of said input port of said second optical filter set and extending in the same general direction as said input port and being operable to transmit said third optical wavelength; and
a reflection port generally opposed to said transmission port for reflecting said second wavelength and extending in a general direction approximately 180 degrees reversed from the direction of said input port and being operable to reflect said second wavelength away from said second optical filter set in a general direction substantially parallel with said transmission port of said first optical filter set for reflecting said second optical wave length; and
a reflection member downstream of said transmission port of said second optical filter set for reflecting said third optical wavelength in a general direction approximately 180 degrees reversed from the direction of said transmission port of said second optical filter set, wherein said three optical wavelengths carried to the wavelengths multiplexer from an optical fiber are divided into three discrete optical wavelengths for use in transmitting three distinct sets of well logging tool data without bending of said optical wavelengths within said optical wavelengths multiplexer.

2. An optical wavelengths multiplexer for a well logging tool as defined in claim 1 and wherein said reflection member comprises:
a third filter set and having an input port to receive the third optical wavelength, and a reflection port for reflecting the third optical wavelength in the direction of said first and second optical wavelengths.

3. An optical wavelengths multiplexer for a well logging tool as defined in claim 1 and wherein said reflection member comprises:
an optical mirror for reflecting said third optical wavelength in the direction of said first and second optical wavelengths.

4. An optical wavelengths multiplexer for a well logging tool as defined in claim 1 wherein said first optical filter set includes:
a thin film optical filter for transmission of said first optical wavelength and reflection of said second and third optical wavelengths.

5. An optical wavelengths multiplexer for a well logging tool as defined in claim 4 wherein said first optical filter set includes:
a first GRIN lens positioned on an input side of said thin film optical filter for focusing at least said first optical wavelength onto said thin film optical filter and collimating optical wavelengths reflected from said thin film filter; and
a second GRIN lens positioned on an output side of said thin film optical filter for collimating said first optical wavelength transmitted by said thin film optical filter.

6. An optical wavelengths multiplexer for a well logging tool as defined in claim 4 wherein said second optical filter set includes:
a thin film optical filter for reflection of said second optical wavelength and transmission of said third optical wavelength.

7. An optical wavelengths multiplexer for a well logging tool as defined in claim 6 wherein said second optical filter set includes:
a first GRIN lens positioned on an input side of said thin film optical filter for reflecting said second optical wavelength and focusing said third optical wavelength; and
a second GRIN lens positioned on an output side of said thin film optical filter for collimating said third optical wavelength transmitted by said thin film optical filter.

8. An optical wavelengths multiplexer for a well logging tool comprising:
a first optical filter set, said first optical filter set having,
an input port operably connected to an optical input fiber carrying at least three distinct optical wavelengths,
a transmission port downstream of said input port of the first optical filter set and a first transmission optical fiber connected to said transmission port and extending in the same general direction as said optical input fiber and being operable to transmit a first optical wavelength; and
a reflection port generally opposed to said transmission port for receiving wavelengths not transmitted by said transmission port and a first reflection optical fiber connected to said reflection port, said reflection port and said first reflection optical fiber extending in a general direction approximately 180 degrees reversed from the direction of said transmission port and said first transmission optical fiber and being operable to transmit the second and third remaining optical wavelengths away from said first optical filter set in a direction 180 degree from the direction of said first transmission optical fiber;
a second optical filter set, said second optical filter set having,
an input port operably connected to said optical reflection port and first reflection optical fiber of said first optical filter set and being operable to receive transmission of said second and third wavelengths from said first optical filter set,
a transmission port downstream of said input port of said second optical filter set and a second transmission optical fiber connected to said transmission port and extending in the same general direction as said input port and said first reflection optical fiber and being operable to transmit said third optical wavelength; and
a reflection port generally opposed to said transmission port for receiving said second wavelength and a second reflection optical fiber connected to said reflection port and extending in a general direction approximately 180 degrees reversed from the direction of said transmission port and being operable to transmit said second wavelength away from said second optical filter set onto said second reflection optical fiber and in a general direction substantially parallel with said transmission port and said first transmission optical fiber of said first optical filter set for reflecting said second optical wave length; and
a reflection member downstream of said transmission port and said second transmission optical fiber of said second optical filter set for reflecting said third optical wavelength in a general direction approximately 180 degrees reversed from the direction of said transmission port of said second optical filter set and onto a third reflection optical fiber extending in the same general direction as said first transmission optical fiber and said second reflection optical fiber, wherein said three optical wavelengths carried to the wavelengths multiplexer from said initial input optical fiber are divided into three discrete optical wavelengths for use in transmitting three distinct sets of well logging tool data without bending of any of said optical fibers within said optical wavelengths multiplexer.

9. An optical wavelengths multiplexer for a well logging tool as defined in claim 8 and wherein said reflection member comprises:
a third filter set and having an input port connected to said second transport optical fiber to receive the third optical wavelength, and a reflection port for reflecting the third optical wavelength onto said third reflector optical fiber in the direction of said first and second optical wavelengths.

10. An optical wavelengths multiplexer for a well logging tool as defined in claim 8 and wherein said reflection member comprises:
an optical mirror for reflecting said third optical wavelength in the direction of said first and second optical wavelengths.

11. An optical wavelengths multiplexer for a well logging tool as defined in claim 8 wherein said first optical filter set includes: a thin film optical filter for transmission of said first optical wavelength and reflection of said second and third optical wavelengths.

12. An optical wavelengths multiplexer for a well logging tool as defined in claim 11 wherein said first optical filter set includes:
a first GRIN lens positioned on an input side of said thin film optical filter for focusing at least said first optical wavelength onto said thin film optical filter and collimating optical wavelengths reflected from said thin film filter onto said first reflection optical fiber; and
a second GRIN lens positioned on an output side of said thin film optical filter for collimating said first optical wavelength transmitted by said thin film optical filter onto said first transmission optical fiber.

13. An optical wavelengths multiplexer for a well logging tool as defined in claim 12 wherein said second optical filter set includes:
a thin film optical filter for reflection of said second optical wavelength;
a first GRIN lens positioned on an input side of said thin film optical filter for reflecting said second optical wavelength and focusing said third optical wavelength; and
a second GRIN lens positioned on an output side of said thin film optical filter for collimating said third optical wavelength transmitted by said thin film optical filter of said second optical filter set.

14. A well logging tool optical multiplexer for operation within a borehole comprising:
an optical fiber input operable for carrying a plurality of discrete wavelengths λ1 . . . λN on a single optical fiber;
a plurality of optical wavelengths multiplexer groups of thin film filter sets connected in series, each of said thin film filter sets comprising:
a first thin film filter set operable to receive an input optical fiber carrying a plurality of optical wavelengths to be multiplexed, said first filter set having a transmission port for transporting a first optical wavelength, and a complementary reflection port for reflecting all other wavelengths carried by the input optical fiber,
a second filter set operable to receive as input all wavelengths reflected by said first filter set and for transporting a second single optical wavelength and reflecting all other optical wavelengths, said all other reflected wave lengths being reflected in the same direction of transmission on an optical fiber as said first optical wavelength, and
a reflection member operable to receive and reflect said second single optical wavelength onto an optical fiber extending in the same direction as the optical fibers of the first isolated wavelength and said all other reflected wavelengths; wherein
two distinct optical wavelengths are isolated by each of said filter sets and remaining undifferentiated wavelengths are passed serially to a next group of filter sets in series and the total number of groups of said filter sets is the total number of wavelengths to be multiplexed (λN) divided by two such that all of the discrete wavelengths (λN) are multiplexed without bending of any optical fibers within said optical wavelength multiplexer.

15. A well logging tool optical multiplexer for operation within a borehole as defined in claim 14 wherein said reflection member comprises:
a third thin film filter set operable to reflect the second single optical wavelength in the same direction as the optical fibers of the first isolated wavelength and said all other reflected wavelengths.

16. A well logging tool optical multiplexer for operation within a borehole as defined in claim 14 wherein said reflection member comprises:
an optical mirror for reflecting said second single optical wavelength onto an optical fiber extending in the same direction as the optical fibers of the first isolated wavelength and said all other reflected wavelengths.

17. A well logging tool optical multiplexer for operation within a borehole as defined in claim 14 wherein each of said filter sets comprises:
a thin film optical filter and a first GRIN lens positioned on an input side of said thin film optical filter and a second GRIN lens positioned on an outlet side of said thin film optical filter.

18. A method for multiplexing an input signal down hole and isolating spectral components within a subsurface logging tool comprising the steps of:
(a) emitting a plurality of wavelengths (λ1 . . . λN ) along a single optical fiber using an opto-electronic surface system;
(b) filtering said wavelengths on said single optical fiber using a multiplexer comprising successively disposed thin film filter sets to isolate optical wavelengths centered on thin film filters, each of said thin film filter sets including,
transmitting a first optical wavelength centered on a first thin film optical filter and reflecting all other wavelengths received;
transmitting a second optical wavelength centered on a second thin film optical filter receiving said all other reflected wavelengths from said first thin film optical filter
reflecting all remaining optical wavelengths from said second thin film optical filter,
reflecting said second optical wavelength in the direction of transmission of said first optical wavelength; and
(c) repeating the steps of (b) until all of the optical wavelengths (λ1 . . . λN) are multiplexed into discrete channels for use in transmitting down hole data up to said opto-electronic surface system without bending said optical fiber.

19. A method for multiplexing an input signal and isolating spectral components within a subsurface logging tool as defined in claim 18 wherein said step of transmitting said first and second optical wavelengths includes the step of
collimating said optical wavelengths onto an optical fiber for
transmission without bending of the optical fiber.

20. A method for multiplexing an input signal and isolating spectral components within a subsurface logging tool as defined in claim 19 wherein said step of reflecting said all remaining wavelengths and said second optical wavelength includes the step of
collimating said optical wavelengths onto an optical fiber for
transmission without bending of the optical fiber.

21. A method for multiplexing an input signal and isolating spectral components within a subsurface logging tool as defined in claim 19 and further comprising the step of:
attaching down hole data to each of said optical wavelengths and returning said wavelengths carrying down hole data back through said down hole multiplexer and onto said single optical fiber for transmission to the surface for de-multiplexing and data analysis.
